(19) United States
(12) Patent Application Publication
(10) Pub. No.: US 2018/0125734 A1
(43) Pub. Date: May 10, 2018

(54) TRACKED MOBILITY DEVICE

(71) Applicant: T.G. Underwood LLC, Rising Sun, IN (US)

(72) Inventors: Travis Underwood, Patriot, IN (US); Benjamin Robert Low, Columbia, MO (US)

(21) Appl. No.: 15/631,019

(22) Filed: Jun. 23, 2017

Related U.S. Application Data
(63) Continuation of application No. 15/067,226, filed on Mar. 11, 2016, now abandoned.
Application No. 15/067,226 is a continuation of application No. PCT/US2014/055395, filed on Sep. 12, 2014.
Application No. PCT/US2014/055395 is a continuation-in-part of application No. 14/024,956, filed on Sep. 12, 2013, now abandoned.
Application No. 14/024,956 is a continuation-in-part of application No. 13/765,182, filed on Feb. 12, 2013, now Pat. No. 8,783,392.
Application No. 13/765,182 is a continuation-in-part of application No. 12/849,897, filed on Aug. 4, 2010, now Pat. No. 8,371,403.
(60) Provisional application No. 61/231,160, filed on Aug. 4, 2009.

(51) Int. Cl. A61G 5/06; B62D 55/12; B62D 55/08; B62D 55/075; B62D 55/02; A61G 5/10; A61G 5/12; A61G 5/04

(52) U.S. Cl. CPC A61G 5/066; B62D 55/12; B62D 55/08; B62D 55/075; B62D 55/02; A61G 2203/14; A61G 5/125; A61G 5/1089; A61G 5/04; A61G 5/128; A61G 5/042; A61G 5/10

(57) ABSTRACT

A tracked mobility device includes a pair of track drives having a rear weight-bearing wheel assembly, a center weight-bearing wheel assembly, a forward weight-bearing wheel assembly, and a front roller assembly. The rear weight-bearing wheels, the center weight-bearing wheels, and the forward weight-bearing wheels are fixed to the frame at a height effective to cause the main weight-bearing surface to always have a “V”-shaped lower surface when viewed from the side. The center weight-bearing wheels, the forward weight-bearing wheels, and the front rollers are fixed to the frame at a height effective to cause that portion of each track drive always to have a “V”-shaped lower surface when viewed from the side. At least one powered drive wheel is provided, and at least one of the rollers is a tensioning roller.

### REFERENCES TO RELATED APPLICATIONS

This application is a continuation of U.S. patent application Ser. No. 15/067,226, filed Mar. 11, 2016, which is a continuation of PCT Application No. PCT/US2014/055395, filed Sep. 12, 2014, which is a continuation-in-part of U.S. patent application Ser. No. 14/024,956, filed Sep. 12, 2013 (pending), which is a continuation-in-part of U.S. patent application Ser. No. 13/765,182, filed Feb. 12, 2013 (now U.S. Pat. No. 8,783,392), which is a continuation-in-part of U.S. patent application Ser. No. 12/849,897, filed Aug. 4, 2010 (now U.S. Pat. No. 8,371,403), which claims the benefit of U.S. Provisional Application No. 61/231,160 filed, Aug. 4, 2009 (now expired), all of which are hereby incorporated herein by reference.

### FIELD OF THE INVENTION

The present invention relates generally to devices for transporting an individual, and more particularly to a personally mobility device that is powered by a track or pair of tracks.

### BACKGROUND

Military veterans are increasingly returning from assignment overseas with injuries that compromise their ability to participate in outdoor activities such as hunting and fishing. While personal mobility devices with room for one user and a small amount of cargo are known, those devices typically do not allow the mobility and stability that is needed by veterans who desire to be active in spite of injuries to their legs. For example, prior art wheeled mobility devices cannot traverse rough or uneven terrain, and prior art tracked mobility devices typically contact the ground with a long and wide footprint that is too big for use indoors. Tracked mobility devices may also require significant power to overcome the resistance of friction during movement, and can cause significant damage to carpets or floors when used indoors. Further, the turning radius of a tracked vehicle is typically larger than the turning radius of a wheeled vehicle due to the length of the track.

Applicant's prior U.S. Pat. No. 8,371,403 sought to address problems associated with prior art mobility vehicles by providing improvements to tracked mobility devices. Similarly, applicant's prior U.S. Pat. No. 8,783,392 discloses other improvements to tracked mobility devices. In spite of those improvements, a need continues to exist for improvements to personal mobility vehicle that will improve the low-friction, quick-turning, indoor and outdoor drivability of the device while still providing the superior off-road capability of a tracked vehicle. The present invention addresses that need.

### SUMMARY OF THE INVENTION

In one aspect of the present invention there is provided a tracked mobility device comprising: A tracked mobility device, comprising:
a) a frame supporting a seat assembly;
b) a pair of track drives connected to said frame, with each track drive comprising flexible track rotating around a set of wheels and/or rollers,
   wherein each set of wheels and/or rollers includes a powered drive wheel, a rear weight-bearing wheel, a center weight-bearing wheel, a forward weight-bearing wheel, and a front roller. The powered drive wheel may be one of the weight-bearing wheels, such as the rear weight-bearing wheel, or it may be another wheel. The powered drive wheel may be provided at any location relative to the other wheels and/or rollers, but it is preferably provided at one “end” of the track (e.g., the front end or the rear end) to provide substantial contact between the drive wheel and the track.

The rear weight-bearing wheel, the center weight-bearing wheel, and the forward weight-bearing wheel are fixed to the frame at a height effective to cause the main weight-bearing surface of each track drive to always have a “V”-shaped lower surface when viewed from the side, and never to have a flat lower surface when viewed from the side. The “V”-shape is accordingly defined by the portions of the track that extend from the rear weight-bearing wheel, past the center weight-bearing wheel, and to the forward weight-bearing wheel.

The rear end portion of each track preferably contacts the rear surface of the rear weight-bearing wheel, the front end portion of the front roller, and the lower portions of the central weight-bearing wheel and the forward weight-bearing wheel. The upper surfaces of the central weight-bearing wheel and the forward weight-bearing wheel preferably remain free from contact with the track.

The center weight-bearing wheel, the forward weight-bearing wheel, and the front roller are fixed to the frame at a height effective to cause the forward portion of each track drive also to have a “V”-shaped lower surface when viewed from the side, and never to have a flat lower surface when viewed from the side. This second “V”-shape is accordingly defined by the portions of the track that extend from the center weight-bearing wheel, past the forward weight-bearing wheel, and to the forward roller.

A wheelie bar assembly is preferably connected to the rear of the device to add stability with respect to backward tipping during acceleration or forward movement, particularly up inclines.

A variable-height rear wheel assembly is also optionally connected to the frame. The variable-height rear wheel assembly may comprise a rear wheel that is movable up or down to allow the wheel to make contact with the ground or to be raised from the ground. When the variable-height rear wheel is positioned in its down position the rear end portion of the track drive may be raised from the ground, causing the device to contact the ground at a smaller portion of the track drive. This allows the rear wheel to cooperate with the forward portion of each of said track drives to provide a three-point contact with a flat surface.

A controller effective for controlling the speed and direction of rotation of each of the track drives is also preferably provided.

In some embodiments the device may include additional wheels and/or rollers to maintain appropriate tension and alignment of the flexible track.

The device includes a seat assembly. In some embodiments the seat assembly includes a set of suspension elements, and particularly includes a set of air suspension elements. The seat assembly may be adjustable to allow the seat to be raised, and/or lowered, and/or tilted forward, and/or tilted rearward, etc.

In some embodiments the seat assembly additionally includes an arm rest on one side of the device, wherein said arm rest has a first, “up” position that blocks access to the seat from one side, and a second, “down” position that does not block access to the seat from that side. In some embodiments the device additionally includes a canopy mounted to the device to protect a user of the device from sun and/or rain. In some embodiments the seat assembly includes a seat and a footrest, and wherein the seat assembly is attached to the frame in a manner effective to be positioned in a first position that blocks access to the space beneath the seat, and in a manner effective to be positioned in a second position that allows access to the space beneath the seat.

### DESCRIPTION OF THE DRAWINGS

FIG. 1 is a side view of the tracked mobility device of the present invention according to one preferred embodiment.

FIG. 2 is a side elevational view of one embodiment of a drive track for the tracked mobility device of the present invention.

FIG. 3 is a perspective view of one embodiment of the tracked mobility device of the present invention according to one preferred embodiment.

FIG. 4 is a perspective view of a rear wheel assembly for one embodiment of the tracked mobility device of the present invention.

FIG. 5 is a perspective view of an arm rest assembly for the tracked mobility device of the present invention, with the assembly in the “up” position.

FIG. 6 is a perspective view of an arm rest assembly for the tracked mobility device of the present invention, with the assembly in the “down” position.

FIG. 7 is a perspective view of a canopy assembly for the tracked mobility device of the present invention, according to one preferred embodiment.

FIG. 8 is a side view of the tracked mobility device of the present invention, according to one embodiment, showing the seat assembly in its raised position to allow access to the space beneath the seat.

FIG. 9 is another side view of the tracked mobility device of the present invention according to one embodiment.

FIG. 10 is a perspective view of the rear end portion of the tracked mobility device of the present invention, according to one embodiment.

FIG. 11 is a perspective view of the seat connection assembly of the tracked mobility device of the present invention, according to one embodiment.

FIG. 12 is a perspective view of a pneumatic seat suspension cup for a seat connection assembly of the tracked mobility device of the present invention, according to one embodiment.

FIG. 13 is a perspective view of a track drive for the tracked mobility device of the present invention, according to one embodiment.

FIG. 14 is a perspective view of components of a track drive for the tracked mobility device of the present invention, according to one embodiment.

FIG. 15 is a perspective view of a track drive and a track tensioning assembly for the tracked mobility device of the present invention, according to one embodiment.

FIG. 16 is a perspective view of components for a track tensioning assembly for the tracked mobility device of the present invention, according to one embodiment.

FIG. 17 is a perspective view of components for a track tensioning assembly for the tracked mobility device of the present invention, according to one embodiment.

FIG. 18 is a perspective view of components for a track tensioning assembly for the tracked mobility device of the present invention, according to one embodiment.

FIG. 19 is a perspective view of components for a track tensioning assembly for the tracked mobility device of the present invention, according to one embodiment.

FIG. 20 is a side elevational view of another embodiment of the present invention.

FIG. 21 is a front elevational view of one embodiment of the tracked mobility device of the present invention.

FIG. 22 is a perspective view of one embodiment of the tracked mobility device of the present invention.

FIG. 23 is an exploded perspective view of one embodiment of the tracked mobility device of the present invention.

FIG. 24 is an exploded front elevational view of one embodiment of certain aspects and features of one embodiment of the present invention.

FIG. 25 is an exploded side elevational view of certain aspects and features of one embodiment of the present invention.

FIG. 26 is a side elevational view of one embodiment of the present invention.

FIG. 27 is a side elevational view of the track drives of one embodiment of the present invention, showing the shallow “V” shape of the lower track surface.

FIG. 28 is a side elevational view of another embodiment of the present invention.

FIG. 29 is a perspective view of the embodiment of FIG. 28.

FIG. 30 is another perspective view of the embodiment of FIG. 28.

FIG. 31 is a perspective view of a frame assembly that may be used in certain embodiments of the present invention.

FIG. 32 shows a pair of wheels or rollers mounted to a portion of the frame of certain embodiments of the present invention.

FIG. 33 is another perspective view of a frame assembly that may be used in certain embodiments of the present invention.

### DESCRIPTION OF PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

The present invention provides an improved personal mobility device. In one embodiment of the present invention there is provided a tracked mobility device comprising: a) a frame supporting a seat assembly; and b) a pair of track drives connected to the frame, with each track drive comprising flexible track rotating around a set of wheels and/or rollers. Each set of wheels and/or rollers includes a powered drive wheel, a rear weight-bearing wheel, a center weight-bearing wheel, a forward weight-bearing wheel, and a front roller. The powered drive wheel may be one of the weight-bearing wheels, such as the rear weight-bearing wheel, or it may be another wheel. The powered drive wheel may be provided at any location relative to the other wheels and/or rollers, but it is preferably provided at one “end” of the track (e.g., the front end or the rear end) to provide substantial contact between the drive wheel and the track.

The rear weight-bearing wheel, the center weight-bearing wheel, and the forward weight-bearing wheel are fixed to the frame at a height effective to cause the main weight-bearing surface of each track drive to always have a “V”-shaped lower surface when viewed from the side, and never to have a flat lower surface when viewed from the side. The “V”-shape is accordingly defined by the portions of the track that extend from the rear weight-bearing wheel, past the center weight-bearing wheel, and to the forward weight-bearing wheel.

The rear end portion of each track preferably contacts the rear surface of the rear weight-bearing wheel, the front end portion of the front roller, and the lower portions of the central weight-bearing wheel and the forward weight-bearing wheel. The upper surfaces of the central weight-bearing wheel and the forward weight-bearing wheel preferably remain free from contact with the track.

The center weight-bearing wheel, the forward weight-bearing wheel, and the front roller are fixed to the frame at a height effective to cause the forward portion of each track drive to also have a “V”-shaped lower surface when viewed from the side, and never to have a flat lower surface when viewed from the side. This second “V”-shape is accordingly defined by the portions of the track that extend from the center weight-bearing wheel, past the forward weight-bearing wheel, and to the forward roller.

A wheelie bar assembly is preferably connected to the rear of the device to add stability with respect to backward tipping during acceleration or forward movement, particularly up inclines.

A variable-height rear wheel assembly is also optionally connected to the frame. The variable-height rear wheel assembly may comprise a rear wheel that is movable up or down to allow the wheel to make contact with the ground or to be raised from the ground. When the variable-height rear wheel is positioned in its down position the rear end portion of the track drive may be raised from the ground, causing the device to contact the ground at a smaller portion of the track drive. This allows the rear wheel to cooperate with the forward portion of each of said track drives to provide a three-point contact with a flat surface.

A controller effective for controlling the speed and direction of rotation of each of the track drives is also preferably provided.

In some embodiments the device may include additional wheels and/or rollers to maintain appropriate tension and alignment of the flexible track.

The device includes a seat assembly. In some embodiments the seat assembly includes a set of suspension elements, and particularly includes a set of air suspension elements. The seat assembly may be adjustable to allow the seat to be raised, and/or lowered, and/or tilted forward, and/or tilted rearward, etc.

In some embodiments the seat assembly additionally includes an arm rest on one side of the device, wherein said arm rest has a first, “up” position that blocks access to the seat from one side, and a second, “down” position that does not block access to the seat from that side. In some embodiments the device additionally includes a canopy mounted to the device to protect a user of the device from sun and/or rain. In some embodiments the seat assembly includes a seat and a footrest, and wherein the seat assembly is attached to the frame in a manner effective to be positioned in a first position that blocks access to the space beneath the seat, and in a manner effective to be positioned in a second position that allows access to the space beneath the seat.

In another embodiment the present invention provides a tracked personal mobility device, comprising:
a) a frame assembly;
b) a pair of track drives directly or indirectly mounted to the frame assembly, with each track drive comprising:
   i) a rear weight-bearing wheel (R);
   ii) a center weight-bearing wheel (CWB);
   iii) a forward weight-bearing wheel (FWB);
   iv) a forward roller (FR);
   iv) an upper roller (UR);
   v) an endless track looped around and contacting all of said wheels to define:
      A) a first linear portion R-CWB between the rear weight-bearing wheel and the center weight-bearing wheel;
      B) a second linear portion CWB-FWB between the center weight-bearing wheel and the forward weight-bearing wheel;
      C) a third linear portion FWB-FR between the forward weight-bearing wheel and the forward roller;
      D) a fourth portion FR-UR between the forward roller and the upper roller;
      E) a fifth portion UR-R between the upper roller and the rear wheel;
c) a seat assembly;
d) a motor to drive the track drives; and
e) a controller to control the speed and direction of rotation of the power/drive wheel.

As with all of the disclosed embodiments, the embodiment previously disclosed may additionally include a rear wheel assembly, comprising:
i) an multi-directional wheel; and
ii) an actuator to raise the multi-directional wheel to a height above the ground, and to lower the multi-directional wheel to a height that would be lower than the ground.

A “wheelie bar” to prevent the device from tipping too far backward may also be provided on any of the embodiments disclosed herein.

A controller effective for controlling the speed and direction of rotation of each of the track drives may be provided on any of the embodiments disclosed herein.

In some embodiments the device additionally includes an arm rest on one side of the device, wherein said arm rest has a first, “up” position that blocks access to the seat from one side, and a second, “down” position that does not block access to the seat from that side. In some embodiments the device additionally includes a canopy mounted to the device to protect a user of the device from sun and/or rain. In some embodiments the seat assembly includes a seat and a footrest, and wherein the seat assembly is attached to the frame in a manner effective to be positioned in a first position that blocks access to the space beneath the seat, and in a manner effective to be positioned in a second position that allows access to the space beneath the seat.

This written description may refer to a contact “point” or a contact “area” or some other zone or surface of contact. However, it is to be appreciated that even when the device is on a completely hard and flat surface, the contact “points” are actually small areas that are typically substantially linear according to the width of the relevant wheel and/or track. Accordingly, applicant's reference to one or more contact “points” is not intended to be literally limited to points of contact, but is instead intended to refer to the relatively small contact areas that obtain when the device is standing or moving on a flat, hard surface.

Reference will now be made to various embodiments and/or features. It is to be appreciated that any or all of these embodiments and/or features may be used alone or in combination with any other embodiment or feature.

1. The Track Drives.

Two track drives are preferably used on the inventive mobility device. Each track drive preferably comprises or consists essentially of one or one pair of rear weight-bearing wheels, two or two pairs of center weight-bearing wheels, two or two pairs of forward weight-bearing wheels, one or one pair of forward rollers, one or one pair of upper rollers, and a flexible track.

Each track drive includes a powered drive wheel. The powered drive wheel may be one of the wheels or “rollers” mentioned above, or it may be an addition wheel. In one preferred embodiment the powered drive wheel is provided at the rear end of the track, with the rear surface of the powered drive wheel contacting the rear portion of the flexible track. In an alternative embodiment, the front wheel/roller may be a powered wheel, and the center and rear wheels/rollers may be unpowered. In that embodiment the front surface of the powered front wheel will contact the front end portion of the flexible track.

The powered drive wheels are preferably “sprocket-drive” wheels with holes extending through the surface to cooperate with corresponding spikes on the inner surface of the flexible track band. The sprocket drive configuration allows the drive wheel to grip the flexible track band to avoid slipping. Alternatively, the powered drive wheel can have a flat outer surface, or a ridged outer surface with a ridge spacing effective to cooperate with corresponding ridges on the track, or the sprocket drive affect may be obtained by providing spikes on the wheels and corresponding holes in the flexible track band.

Each powered drive wheel functions to turn the flexible track of a track drive, thereby moving the device in either a forward or a rearward direction. Each drive wheel is capable of moving at a variable speed in either a forward or a rearward direction.

The drive wheel is preferably powered by a motor that is may be mounted to the vehicle frame. The motor is effective for turning a drive shaft or axle, which turns the drive wheel. The motor may be an electric motor such as an AC- or DC-battery powered motor. The motor is effective for moving the drive shaft/axle and associated track in the forward or rearward direction.

Each motor preferably drives one drive shaft, which preferably comprises a ¾ inch axle. The drive shaft may be driven directly by the motor, or it may be driven by a mechanical linkage. Gears to adjust the rotational speed of the drive shaft are preferably included.

The powered drive wheel preferably has an outer diameter of between 6 inches and 14 inches, with a diameter of between about 8 inches and 12 inches, and most preferably at least about 10 inches, being more preferred.

A group of three weight-bearing wheels is also provided in the track drive. The weight-bearing wheels preferably comprise a rear weight-bearing wheel, a center weight-bearing wheel, and a forward weight-bearing wheel. These wheels are referred to herein as weight-bearing wheels because they typically bear the weight of the device during normal operation, although some of the weight may be borne by other wheels when the device is being used. Additionally, in some periods of use one or more of the “weight-bearing” wheels may bear little if any of the weight of the device during some times of use.

The weight-bearing wheels (or the various pairs of weight-bearing wheels) are preferably attached to the frame at a position effective to cause the bottom portions of the track to form a shallow “V” shape. In that embodiment, the rear weight-bearing wheel, the center weight-bearing wheel, and the forward weight-bearing wheel are fixed to the frame at a height effective to cause the main weight-bearing surface of each track drive to always have a “V”-shaped lower surface when viewed from the side, and never to have a flat lower surface when viewed from the side. The “V”-shape is accordingly defined by the portions of the track that extend from the rear weight-bearing wheel, past the center weight-bearing wheel, and to the forward weight-bearing wheel.

The rear end portion of each track preferably contacts the rear surface of the rear weight-bearing wheel, the front end portion of the front roller, and the lower portions of the central weight-bearing wheel and the forward weight-bearing wheel. The upper surfaces of the central weight-bearing wheel and the forward weight-bearing wheel preferably remain free from contact with the track.

The center weight-bearing wheel, the forward weight-bearing wheel, and the front roller are fixed to the frame at a height effective to cause the forward portion of each track drive to also have a “V”-shaped lower surface when viewed from the side, and never to have a flat lower surface when viewed from the side. This second “V”-shape is accordingly defined by the portions of the track that extend from the center weight-bearing wheel, past the forward weight-bearing wheel, and to the forward roller.

Each of the weight-bearing wheels preferably has a diameter of between about 4 inches and 8 inches, with a diameter of about 6 inches being most preferred.

One or more additional non-powered, non-weight-bearing wheels may also be provided in the track. These rollers wheels may help to keep the flexible track band aligned and moving smoothly over the track. Such roller wheels preferably have a diameter of between about 3 inches and 8 inches, with a diameter of about 4 to 6 inches being most preferred.

In one embodiment an unpowered front roller wheel is preferably provided at the front end of the track. The unpowered front roller wheel is preferably a free-rolling roller that extends the track distance and properly positions the front track end without restricting track movement. The front roller preferably has a diameter between about 2 inches and 8 inches, and more preferably between about 4 inches and 6 inches, and most preferably about 5 inches. Alternatively, the sprocket drive affect may be obtained by providing spikes on the wheels and corresponding holes in the flexible track band.

In one embodiment a non-weight-bearing, tensioning roller is provided above the weight-bearing wheels. In this embodiment the central weight-bearing wheels contact the flexible track only on their bottoms and their upper surfaces are not contacted by the flexible track. Instead, the upper surface of the non-weight-bearing, tensioning roller contacts the flexible track and the lower surface of the non-weight-bearing, tensioning roller does not contact the flexible track.

The centers (axle height) of the various wheels/rollers may be positioned at a height effective to cause the track to form a shallow “V”-shape along its lower surface. When so positioned, the track may contact a flat, level ground surface only at a single “point” or small area that is less than the diameter of the weight-bearing wheel, as occurs when a rear wheel is lowered to provide a “three-point” contact. Alternatively, the track may contact a flat, level ground surface along the entire portion of the track that passes between the two, center weight-bearing rollers, or between one of the two, weight-bearing rollers and the drive wheel.

In one embodiment one or more of the wheels may include a groove to facilitate alignment of the track. In other embodiments one or more of the “wheels” may actually be a pair of wheels that are provided on each side of a frame member with the space between the wheels providing the groove that facilitates alignment of the track. In other embodiments the track may be aligned on the drive wheel and rollers with an alignment guide that keeps the track centered over the drive wheel and rollers.

Each track comprises a flexible track band that moves continuously as the drive wheel rotates. The tracks may be made of any material with the flexibility and strength to drive a personal mobility vehicle over grass, gravel, concrete, wood, carpet, etc., and is preferably made of a heavy-weight rubber or synthetic material such as is used to make automobile tires. The material preferably includes fibers woven into the material, such as metal, nylon or other synthetic fibers.

In the preferred embodiment the flexible track band has openings that cooperate with similarly-spaced spikes in the drive wheel to facilitate gripping between the track and the drive wheel. This configuration may be referred to as a sprocket drive. The sprocket drive works similarly to a sprocket and chain connection found in bicycles and the like to avoid slippage between the flexible track band and the drive wheel.

In some embodiments the flexible track band may have a cross section shaped as a “T” so that the track can be aligned in grooves in the various wheels and/or in the space between two wheels of a wheel pair. When the track has a “T”-shaped cross section, the track defines a horizontal portion and a vertically-extending portion. The horizontal portion may have a width that extends slightly beyond the width of the rollers, such as a four-inch-wide track for three-inch-wide rollers. The vertically-extending portion is sized to be accepted in grooves in the rollers or in the spaces between the rollers, and is accordingly preferably about ¾ inch tall. In one embodiment the vertical portion of the “T” has a tapered shape to facilitate alignment with the roller grooves. In that embodiment it is preferred that the vertical end (bottom) portion of the “T” is slightly narrower than the (upper) portion of the “T” that connects with the horizontal portion of the track. For example, the bottom end portion may be ½ inch wide when the upper portion that connects with the horizontal part of the track is ¾ inch wide.

As indicated above and as shown in the drawings, the flexible track may contact the ground at a small “point” under one or more of the center drive wheels when the device is standing or moving on a hard, flat surface. Conversely, the flexible track may contact the ground at a larger contact “area” under the center drive wheel and extending forward or rearward when the device is standing or moving on a soft and/or uneven surface. The extended or enlarged contact area may keep the vehicle from sinking too far into the soft terrain much like snow shoes keep a person from sinking into soft snow.

The track drive may be adjustable in length to allow the proper tension to be maintained on the flexible track band. In one embodiment, the front tensioning roller may be moved forward or backward to maintain the proper tension on the track band. Alternatively or additionally, the upper tensioning roller may be moved upward or downward to maintain the proper tension on the track band. A spring mechanism may be provided in either or both of the tensioning arms to push the tensioning roller(s) against the flexible track.

2. The Rear Wheel Assembly.

The mobility device may optionally include a rear wheel assembly that optionally raises and lowers and may function as the third contact point when the vehicle is on a hard, flat surface. In one embodiment the rear wheel assembly comprises a multi-directional wheel with small discs around the circumference which are perpendicular to the rolling direction. Such wheels, which may also be called that omni wheels or poly wheels, ae known to the art and allow the wheel to roll forward or rearward with full force, but also allow the wheel to slide laterally with great ease.

In other embodiments the optional rear wheel assembly may comprise an inner wheel portion having an inner wheel diameter, and a pair of outer wheel portions having a diameter that is smaller, and is preferably at least 10% smaller, than the inner wheel diameter.

In one embodiment the independent rear wheel assembly comprises three wheels sharing a common axle. The three wheels may therefore be identified as the center or inner rear wheel, and the two outer rear wheels. A generally vertical fork assembly, which may include an offset portion, may be used to connect the axle(s) to the frame.

The center rear wheel may have a diameter of between 8 inches and 12 inches, with a diameter of about 10 inches being more preferred. The two outer wheels preferably have a diameter of between 6 inches and 10 inches, with a diameter of about 8 inches being more preferred.

When a “three wheel” embodiment is used instead of the multi-directional wheel embodiment, the first outer wheel may have a diameter at least 10% smaller than the diameter of the center rear wheel. Similarly, the second outer wheel preferably may have a diameter at least 10% smaller than the diameter of the center rear wheel. In alternative embodiments the two outer rear wheels may have a diameter at least 20% smaller than the diameter of the center rear wheel.

Regardless of whether a multi-direction wheel or a three-wheel assembly is used, the optional rear wheel assembly may be mounted to an actuator that is effective to raise and lower the rear wheel assembly. As shown in the drawings, when the rear wheel assembly is raised the rear wheel(s) do not contact the ground and the device is supported only by the two tracks. When the rear wheel assembly is lowered, the rear wheel(s) contacts the ground and the device is in “three-point contact” mode in which the device contacts the ground under the rear wheel(s) and under a small portion of each side track.

As shown in the drawings, when the “three-wheel” rear wheel is used the rear wheel assembly contacts the ground at a small “point” under the center rear wheel when the device is standing or moving on a hard, flat surface. Conversely, the rear wheel assembly contacts the ground at a larger contact “area” under the center rear wheel and the two outer rear wheels when the device is standing or moving on a soft and/or uneven surface. This larger contact area keeps the vehicle from sinking too far into the soft terrain much like snow shoes keep a person from sinking into soft snow.

The rear wheel assembly may be connected to the vehicle frame with a fork that pivots with respect to the frame. This allows the rear wheels to track properly regardless of the direction in which the vehicle is moving. The fork preferably allows the wheel to freely rotate about 360°, thus enabling the wheel to roll in any direction even if a multi-directional wheel is not being used. This makes it possible to easily move the device in any direction without changing its orientation. The fork may include a small amount of offset distance between the center axis of the vertical shaft and the center axis of the wheel. If the wheel is pushed to move in a direction that is not the direction that the wheel is facing, the offset will cause the wheel assembly to rotate around the axis of the vertical shaft to follow behind the direction of movement. Thus, when in motion along a straight line, the independent rear wheel assembly will tend to automatically align to, and rotate parallel to, the direction of travel.

3. The Frame/Body and Controls

The mobility device includes a frame or body to which the two track drives and the rear wheel assembly are attached. The frame/body may be made of metal, plastic, composite, or some other material appropriate for covering the elements that are housed in the body.

The dimensions of the body may vary according to the desired size of the device, but in one preferred embodiment the body has a length of about 22 inches to 24 inches, and a width of about 16 inches to 18 inches. The height of the frame is preferably between about 10 inches and about 16 inches.

In one embodiment the body supports a seat. The seat may be a bench seat, or it may have a back. Arms may be included if desired, and may be sized to accommodate controls that are easily accessible by the user's hand(s).

The device may include controls to control the direction and speed at which each track moves. The device may also include controls to control the actuator(s) which lower the multi-directional wheel(s). The controls may be operated by a joystick which moves forward to move both tracks forward, or moves backward to move both tracks backward, or moves to the left to move the right track forward and the left track backward, or moves to the right to move the left track forward and the right track backward, or any combination of speed and direction for each track. Joystick controls which control the speed and direction of rotation of each drive shaft, and thus of each track, are known to the art. Alternatively, other controls effective to control the speed and/or direction of rotation of each track may be incorporated into the device. Additionally, readouts such as LED readouts to indicate operating conditions such as battery life may be included.

In one embodiment arm rests are provide on the device. Such arm rests may be movable so that they may swing down and out-of-the-way when a user is climbing onto or off of the device.

A seat assembly is also provided on the device. The seat assembly includes a seat, and may also include a foot rest for the user's feet. The seat assembly may be provided with an actuator that allows the seat to be raised or lowered, with adjustment to seat angle also being provided. In one embodiment the seat assembly is provided with a suspension system including a pneumatic cup that allows air pressure to be used to provide a comfortable seat suspension.

In one embodiment of the present invention the seat is pivotable on the frame. Most preferably, the seat is pivotable for at least about 90° in each direction to enable a user to enter and/or exit the vehicle more easily from the side. When side hand rails are included, the complete seat assembly, including handrails, may be pivotable with respect to the frame. Moreover, the seat may be movable to allow access to the space beneath the seat. That space may be used to stow gear, and/or it may be used to hold batteries to power the motor.

The inventive mobility device may have a track length of about 24 inches, but alternatively may have a track length between about 18 inches and 48 inches. The device may have a width or about 29 inches to allow passage through standard door openings.

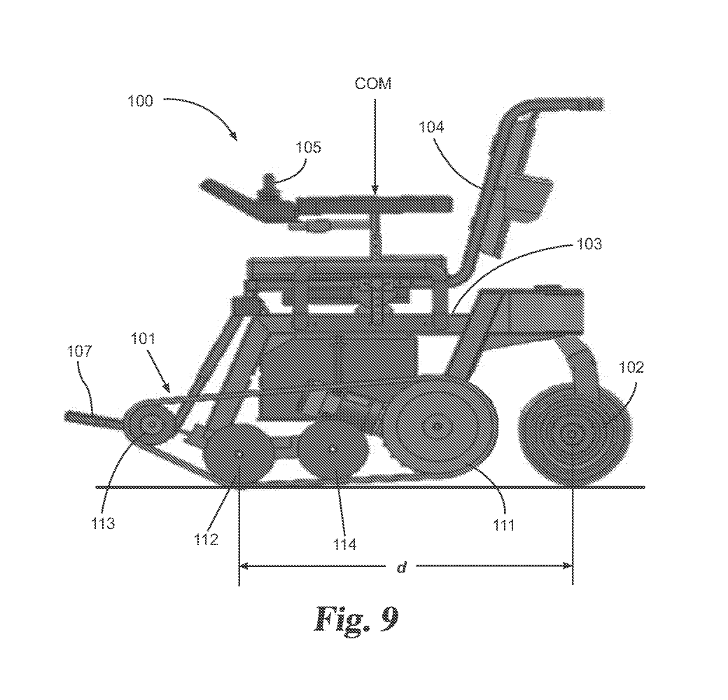

When combined with the independent rear wheel assembly, the device may contact the ground at three points as disclosed herein, with the distance “d” between the two, front-most ground contact points and the single, rearmost ground contact point being between about 22 inches and 32 inches, more preferably between about 24 inches and 30 inches, and most preferably about 28 inches, when viewed from the side as shown in FIG. 9.

The center of gravity (or center of mass) of the device is preferably between the two weight-bearing wheels when the rear wheel assembly is not lowered to contact the ground. When the rear wheel assembly is lowered to contact the ground, the center of gravity/mass is between the three contact points, with the center of gravity/center of mass being at least 8 inches in front of the rearmost ground contact point and at least 8 inches behind the front-most ground contact point. More preferably, the center of gravity/center of mass is at least 10 inches in front of the rearmost ground contact point and at least 10 inches behind the front-most ground contact point to provide improved stability, and most preferably, the center of gravity/center of mass is at least 12 inches in front of the rearmost ground contact point and at least 12 inches behind the front-most ground contact point. In one preferred embodiment the center of gravity/center of mass is about 13 inches in front of the rearmost ground contact point and about 15 inches behind the front-most ground contact point.

When a user is seated in the device and the rear wheel is lowered, the center of gravity of the device/user combination must be between the three contact points, with the center of gravity/center of mass of a device/user combination being at least 8 inches in front of the rearmost ground contact point and at least 8 inches behind the front-most ground contact point with a 150 pound user. More preferably, the center of gravity/center of mass of the device/user combination is at least 10 inches in front of the rearmost ground contact point and at least 10 inches behind the front-most ground contact point (with a 150 pound user) to provide improved stability, and most preferably, the center of gravity/center of mass is at least 12 inches in front of the rearmost ground contact point and at least 12 inches behind the front-most ground contact point. In one preferred embodiment the center of gravity/center of mass of the device/user combination is about 13 inches in front of the rearmost ground contact point and about 15 inches behind the front-most ground contact point.

To provide improved stability when a user is seated in the device, the seat should be positioned so that the center of the seat is at least 8 inches in front of the rearmost ground contact point and at least 8 inches behind the front-most ground contact point. More preferably, the center of the seat is at least 10 inches in front of the rearmost ground contact point and at least 10 inches behind the front-most ground contact point to provide improved stability, and most preferably, the center of the seat is at least 12 inches in front of the rearmost ground contact point and at least 12 inches behind the front-most ground contact point. This prevents the device from tipping forward or backward when a user leans forward or backward in the seat.

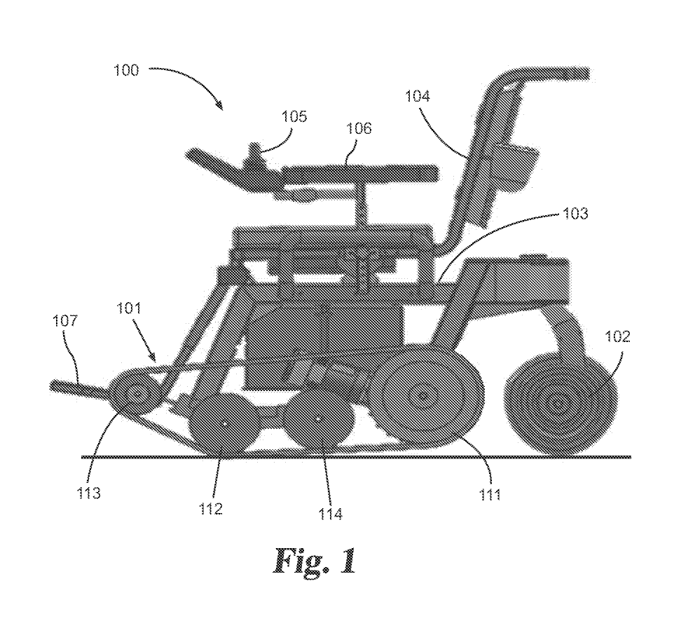

Referring now to the drawings, FIG. 1 shows the tracked mobility device of the present invention according to one preferred embodiment. Tracked mobility device 100 includes a pair of track drives 101 and a rear wheel assembly 102 mounted to a frame 103. Each track drive 101 comprises a flexible track 115 rotating around a set of wheels and/or rollers. Each set of wheels and/or rollers includes a rear powered wheel 111, a central weight-bearing wheel 112, and a front roller/wheel 113. An additional central non-powered, non-weight-bearing roller wheel 114 is also included between rear powered wheel 111 and central weight-bearing wheel 112.

In the embodiment shown in FIG. 1, the rear powered wheel, the central weight-bearing wheel, and the front roller wheel are fixed to said frame at a height effective to cause each track drive always to have a “V”-shaped lower surface when viewed from the side, with the “V”-shape being defined by a raised front end portion, a raised rear end portion, and a lowered central portion, and never to have a flat lower surface when viewed from the side. The raised rear end portion of each track contacts the rear surface of the powered drive wheel, and the raised front end portion of each track contacts the front surface of the unpowered roller wheel. The lowered central portion of each track contacts only the lower surface of the central weight-bearing wheel, with the upper surface of the central weight-bearing wheel being free from contact with the track.

Rear wheel assembly 102 is connected to the frame and comprises a rear wheel positioned at a fixed and constant height with respect to the frame. That fixed and constant height is effective to allow the rear wheel to cooperate with the lowered central portion of each of said track drives to provide a three-point contact with a flat surface.

A seat assembly 104 is also provided on the frame. Seat assembly 104 optionally includes a foot rest 107.

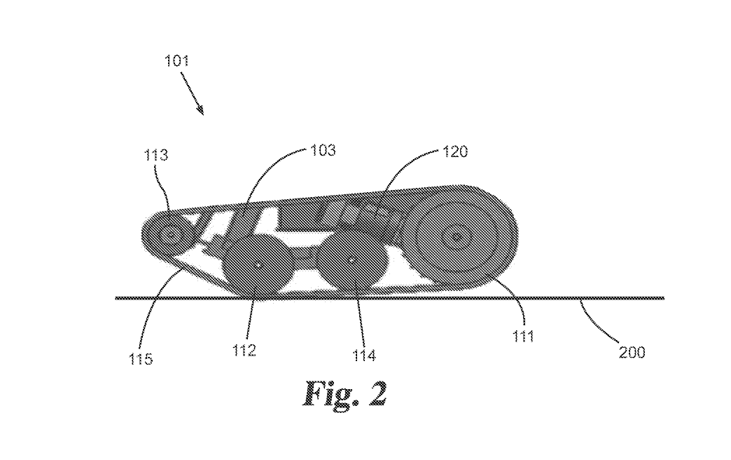

FIG. 2 is a side elevational view of one embodiment of a drive track for the tracked mobility device of the present invention. Drive track 101 includes a flexible track 115 rotating around a set of wheels and/or rollers. Each set of wheels and/or rollers includes a rear powered wheel 111, a central weight-bearing wheel 112, and a front roller/wheel 113. An additional central non-powered, non-weight-bearing roller wheel 114 is also included between rear powered wheel 111 and central weight-bearing wheel 112. A motor 12o powers drive wheel 111. Weight-bearing wheel 112 is mounted to frame 103 so that weight-bearing wheel 112 may cooperate with independent rear wheel 102 to support all of the weight of the device. It can be seen that the bottom surface of track drive 101 forms a shallow “V” with respect to flat ground 200.

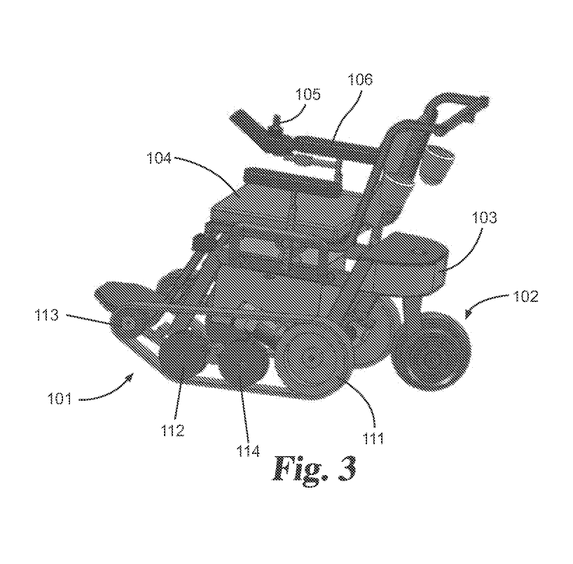

FIG. 3 is a perspective view of one embodiment of the tracked mobility device of the present invention according to one preferred embodiment. Tracked mobility device 100 includes a pair of track drives 101 and a rear wheel assembly 102 mounted to a frame 103. Each track drive 101 comprises a flexible track 115 rotating around a set of wheels and/or rollers. Each set of wheels and/or rollers includes a rear powered wheel 111, a central weight-bearing wheel 112, and a front roller wheel 113. An additional central non-powered, non-weight-bearing roller wheel 114 is also included between rear powered wheel 111 and central weight-bearing wheel 112. A controller 105 effective for controlling the speed and direction of rotation of each of the track drives is also provided. Additionally, arm rests 106 are provided on each side of the device

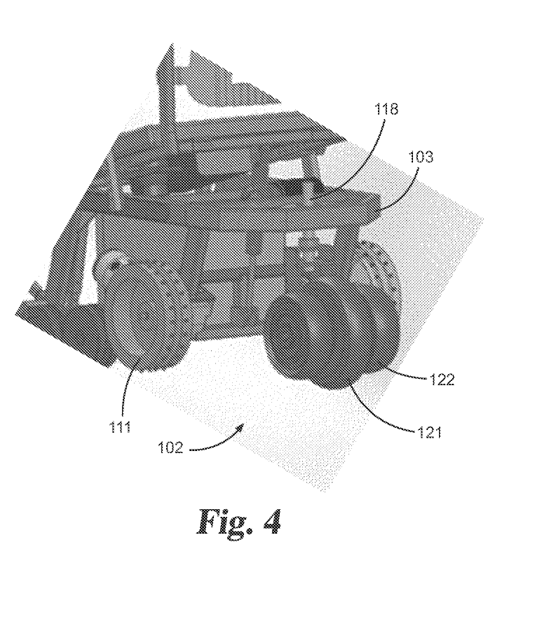

FIG. 4 is a perspective view of an independent rear wheel assembly for the tracked mobility device of the present invention, according to one preferred embodiment. The illustrated independent rear wheel assembly 102 includes a central wheel 121 and a pair of outer wheels 122, with all three wheels being mounted to a single axle. The assembly is attached to frame 103 in a manner effective to allow rear wheel assembly 102 to pivot as necessary to have central wheel 121 roll in a desired direction. The illustrated connection comprises a generally vertical pivot assembly 117, which includes an offset fork portion 118, to connect the axle to the frame.

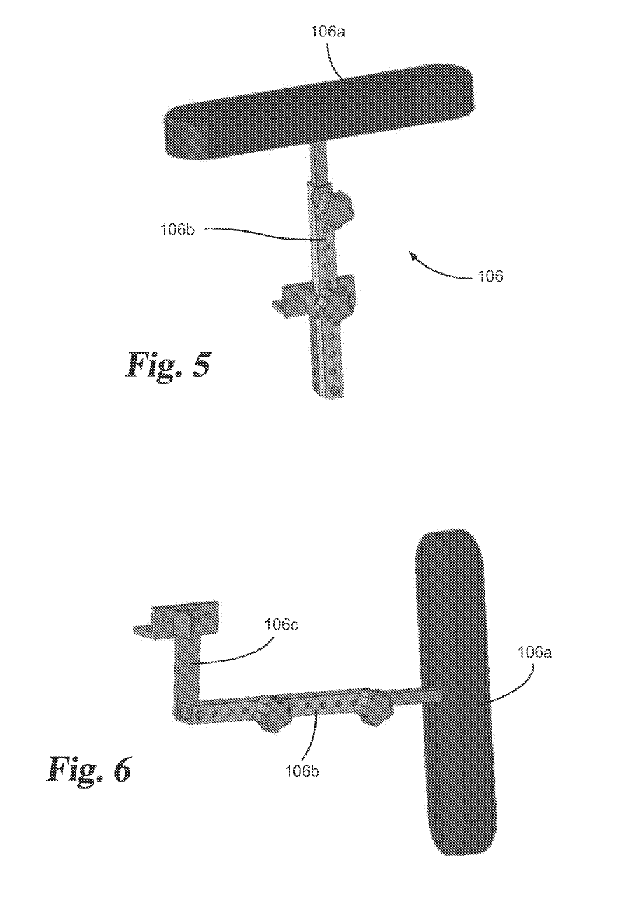

FIG. 5 is a perspective view of an optional arm rest assembly 106 for the tracked mobility device of the present invention, with the assembly in the “up” position. FIG. 6 is a perspective view of arm rest assembly 106 in its “down” position. In both Figures, arm rest assembly 106 includes a rest portion 106a mounted to a swivel arm 106b. Swivel arm 106b is mounted to and swivel with respect to a support 106c. Swivel arm 106b may be locked in its “up” position when in use, or it may be allowed to swivel down and out of the way when a user is climbing onto or down from the mobility device.

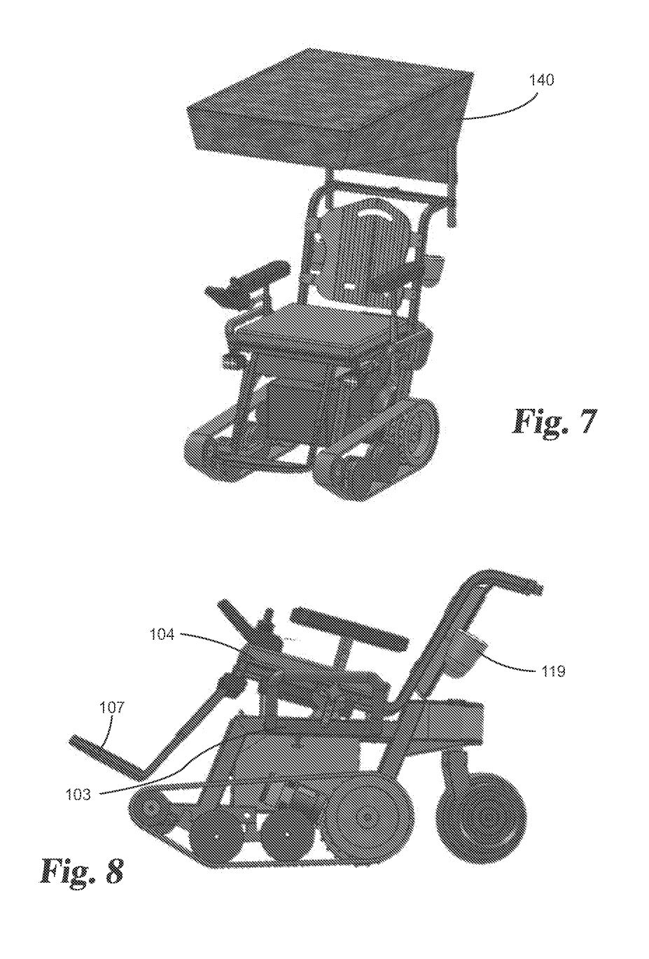

FIG. 7 is a perspective view of a canopy assembly for the tracked mobility device of the present invention, according to one preferred embodiment. Canopy assembly 140 may protect a user from sun and/or rain when the mobility device is used outdoors.

FIG. 8 is a side view of the tracked mobility device of the present invention, according to one preferred embodiment, showing the seat assembly in its raised position to allow access to the space beneath the seat.

FIG. 9 is another side view of the tracked mobility device of the present invention according to one preferred embodiment. In addition to the components previously discussed, a controller 105 effective for controlling the speed and direction of rotation of each of the track drives is illustrated. Additionally, a cup holder 119 is provided. The device illustrated in FIG. 9 is moving backward, as can be seen from the position of the independent rear wheel assembly fork.

As also shown in FIG. 9, the device contacts the ground at three points, with the distance “d” between the front-most ground contact points under the weight-bearing wheel and the rearmost ground contact point under the independent rear wheel being between about 22 inches and 32 inches when viewed from the side as illustrated.

As also shown in FIG. 9, the device has a center of mass “COM” that typically is near the center of the seat. The center of mass may move forward or backward slightly when a user is seated in the device, but that movement is not significant for a 150 to 250 pound user. Center of mass COM is preferably at least 10 inches behind the front end of distance “d” and at least 10 inches in front of the rear end of distance “d,” and is more preferably at least 12 inches behind the front end of distance “d” and at least 12 inches in front of the rear end of distance “d.”

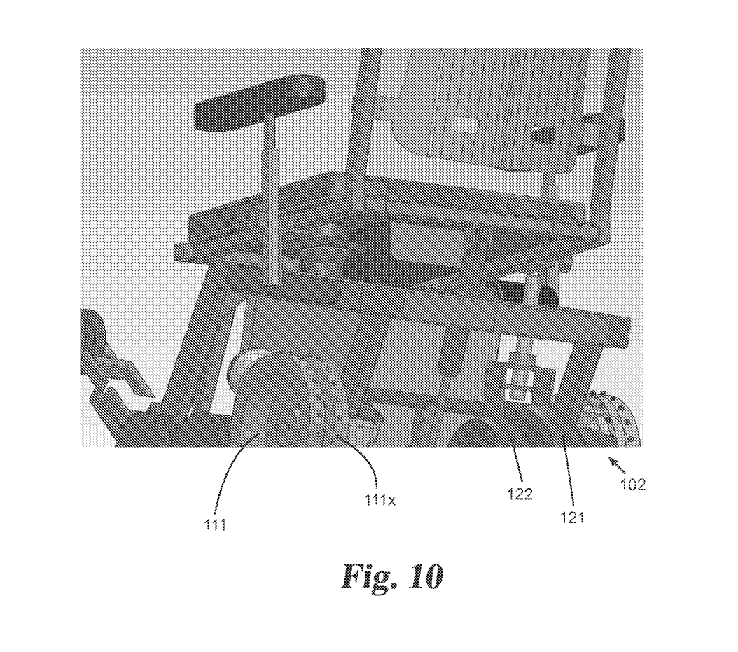

FIG. 10 is a perspective view of the rear end portion of the tracked mobility device of the present invention, according to one preferred embodiment. Rear wheel assembly 102 is shown, including center rear wheel 121 and outer rear wheel 122. Powered drive wheel 111 is also illustrated.

FIG. 11 is a perspective view of the seat connection assembly of the tracked mobility device of the present invention, according to one preferred embodiment. Seat connection assembly 150 includes seat actuator 151 and pneumatic seat suspension cup 152.

FIG. 12 is a perspective view of a pneumatic seat suspension cup 152 for a seat connection assembly of the tracked mobility device of the present invention, according to one preferred embodiment.

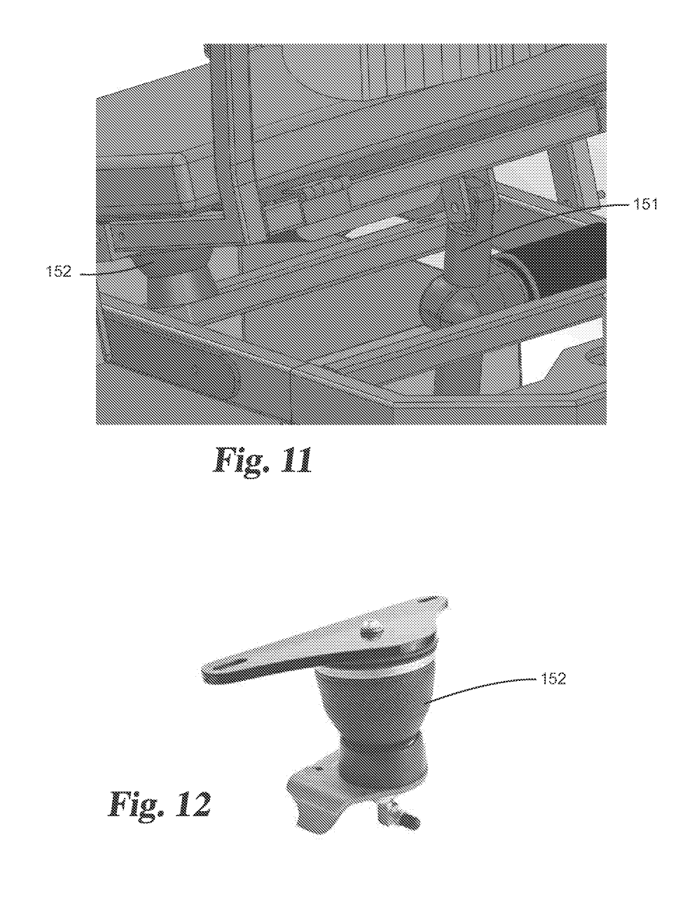

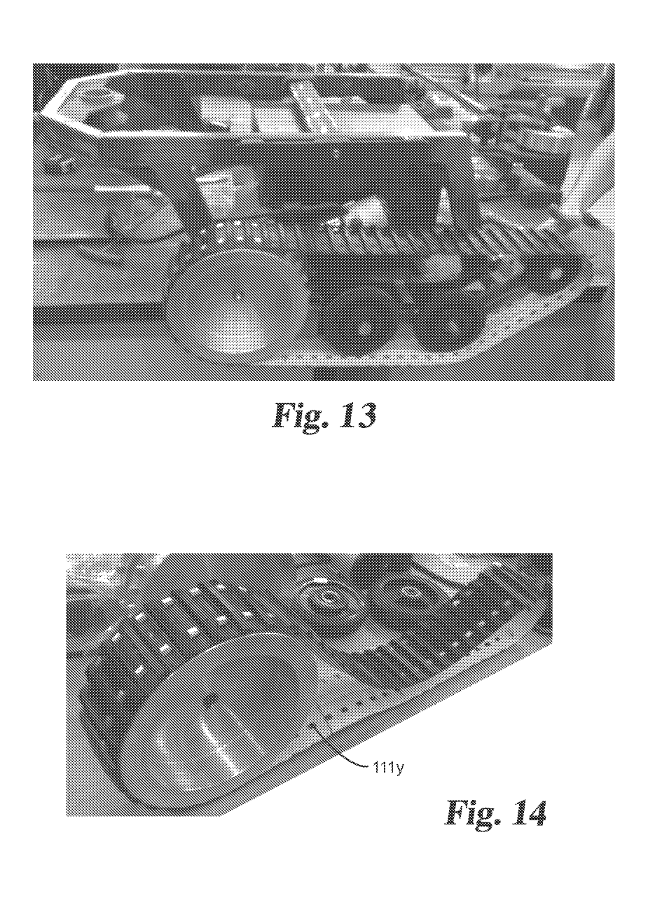

FIG. 13 is a perspective view of a track drive for the tracked mobility device of the present invention, according to one preferred embodiment. The interlinking connection between drive wheel spikes 111x and flexible track band openings 111y is shown.

FIG. 14 is a perspective view of components of a track drive for the tracked mobility device of the present invention, according to one preferred embodiment. Here too, the interlinking connection between drive wheel spikes 111x and flexible track band openings 111y is shown.

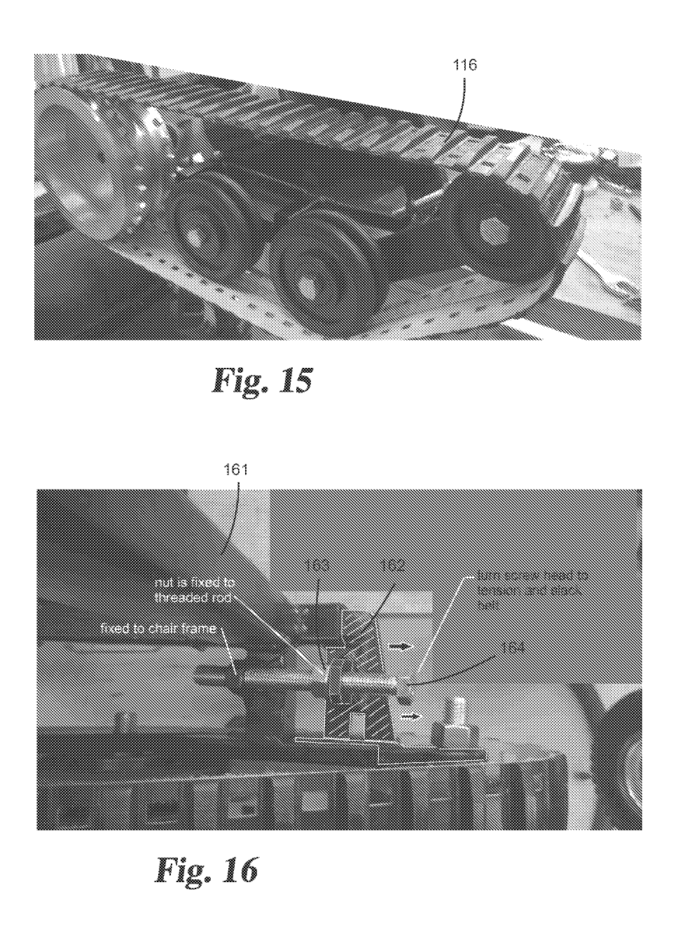

FIG. 15 is a perspective view of a track drive and a track tensioning assembly for the tracked mobility device of the present invention, according to one preferred embodiment. The outer ridges 116 on flexible track band 115 are particularly illustrated.

FIG. 16 is a perspective view of components for a track tensioning assembly for the tracked mobility device of the present invention, according to one preferred embodiment. Track length adjustment assembly 160 includes a fixed bracket 161 and an adjustable bracket 162. Adjustable bracket 162 preferably slides in fixed bracket 161, and may be moved and locked in place by turning a bolt 164. A lock nut 163 locks tensioning bolt 164 when the correct tension is achieved.

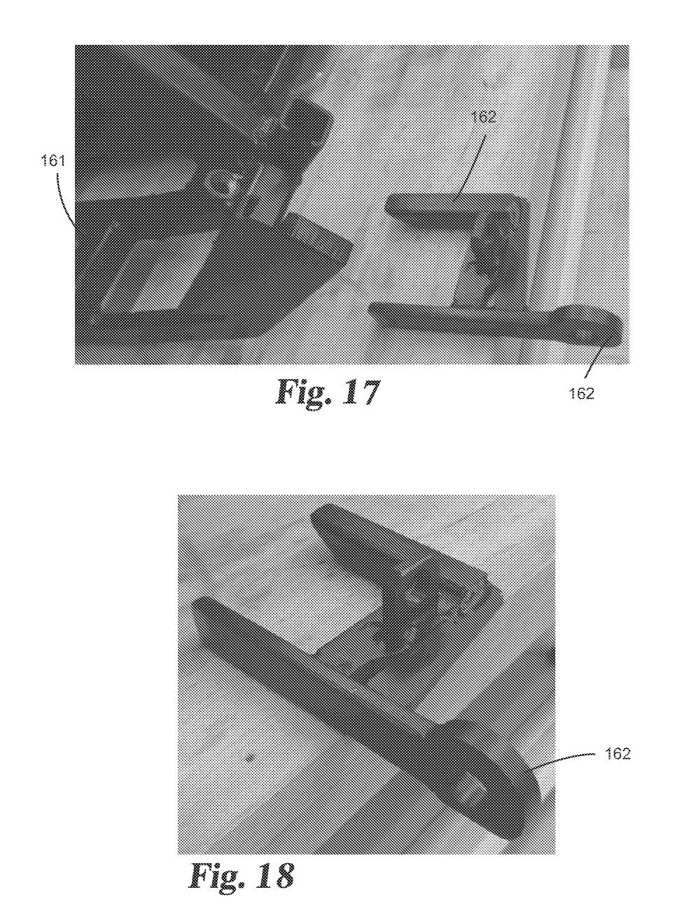

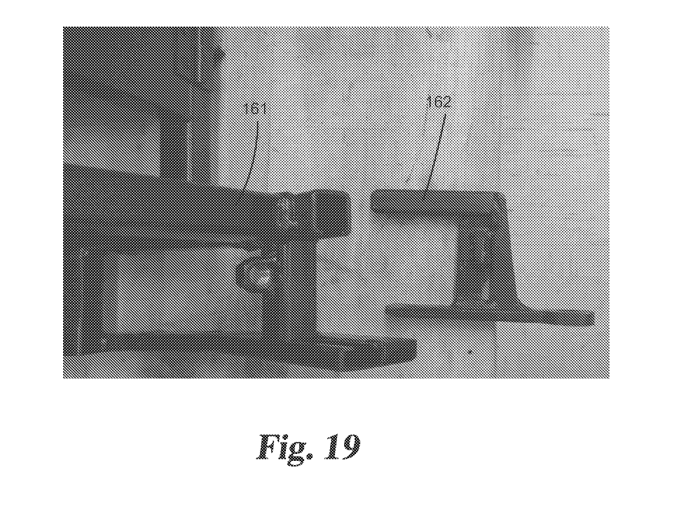

FIG. 17-19 show additional perspective views of components for a track tensioning assembly for the tracked mobility device of the present invention, according to one preferred embodiment. Fixed bracket 161 and movable bracket 162 are particularly shown.

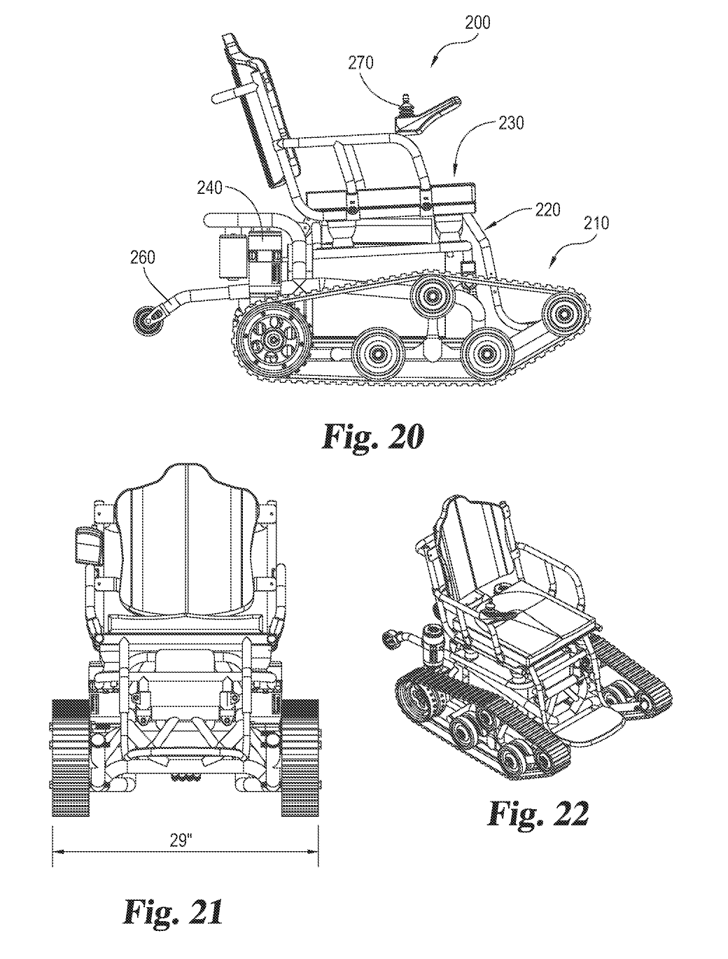

FIG. 20 shows a side elevational view of another embodiment of the present invention. In the illustrated embodiment device 200 includes track drive 210, frame assembly 220, seat assembly 230, power assemblies 240, rear wheel assembly 250 (not clearly visible in the view of FIG. 20), rear wheelie bar assembly 260, and controls 270.

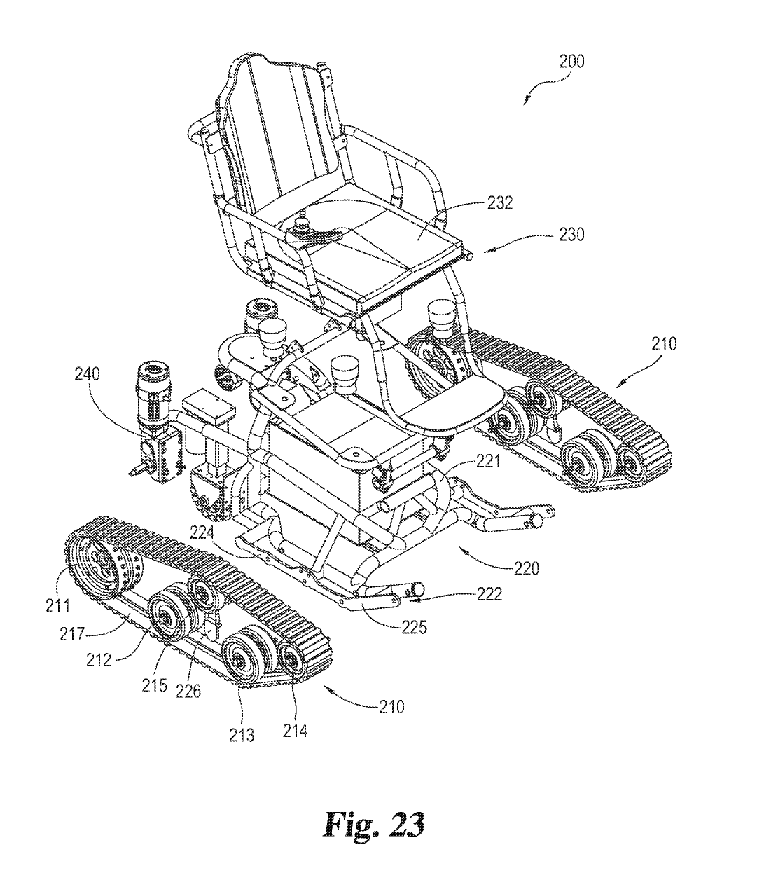

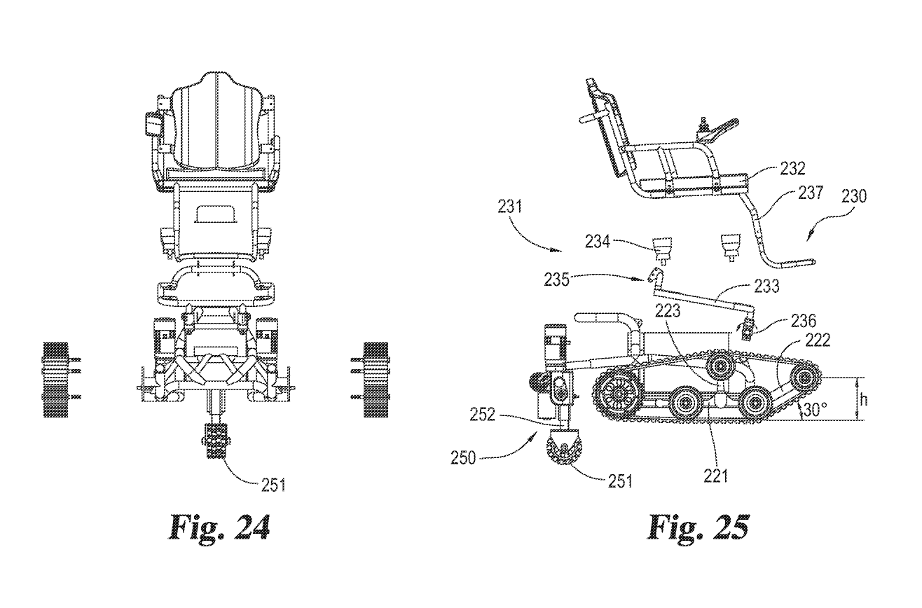

FIGS. 21-27 show alternate views of all or parts of mobility devices according to certain preferred embodiments of the present invention. In those FIGS, track drive 210 includes rear weight-bearing wheel 211, center weight-bearing wheel 212, forward weight-bearing wheel 213, forward roller 214, and upper roller 215. A flexible track 217 is driven over the wheels and rollers.

The illustrated frame assembly 220 includes an upper portion 221 that supports the seat assembly, and track support portions 222 that support the track drives. Each track support portion 222 includes a main, horizontal portion 224 and an upward angled forward portion 225 that holds the forward roller. A vertical post portion 226 extends upward from main, horizontal portion 224 to support the upper tensioning roller. In some embodiments either or both of forward angled portion 225 and vertical post portion 226 may be adjustable to allow a tensioning roller attached thereto (e.g., tensioning roller 215) to be raised or lowered, thus increasing or decreasing the tension on track 217 and allowing the track to be removed from the device.

As shown in FIG. 25, seat assembly 230 may include a seat connection assembly 231 and a seat 232. Seat connection assembly 231 may include middle frame member 233 and pneumatic seat suspension cups 234. A leg and foot rest 237 may extend from seat assembly 230.

Power assemblies 240 provide power to the rear drive wheel as described above.

Rear wheel assembly 250 includes a multi-directional wheel 251 as described herein.

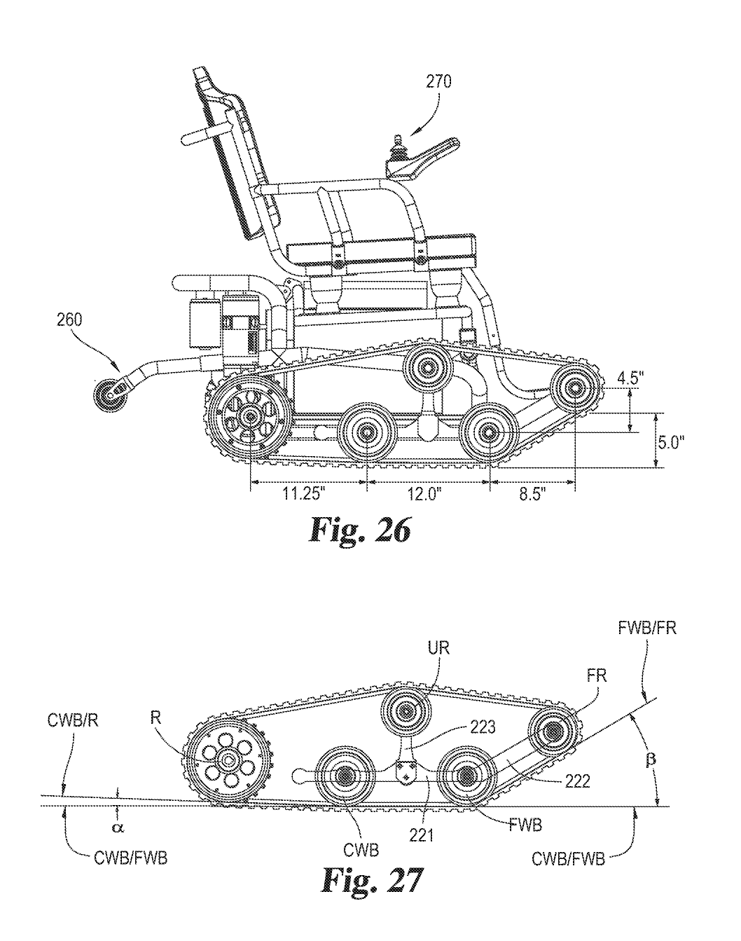

FIG. 26 shows certain preferred dimensions and relative positioning of the various wheels and rollers. In the embodiment illustrated by FIG. 26, the distance between rear weight-bearing wheel RWB and center weight-bearing wheel CWB is preferably between about 10 inches and 14 inches, and is indicated to be between about 11 inches about 12 inches (nominally 11.25 inches) in the drawing. The distance between center weight-bearing wheel CWB and forward weight-bearing wheel FWB is preferably between about 10 inches and 14 inches, and is indicated to be about 12 inches in the drawing. The distance between forward weight-bearing wheel FWB and front roller FR is preferably between about 8 inches and 10 inches, and is indicated to be about 8.5 inches in the drawing.

As to the height of the front roller, the front roller is positioned at a height effective to allow the roller to easily climb normal curbs such as a normal 8 inch curb. Accordingly, front roller FR is preferably provided at a height of about 4 inches to about 5 inches (nominally about 4.5 inches) above the height of forward weight-bearing wheel FWB. This positions the track immediately below front roller FR about 5 inches to 7 inches above the ground level.

FIG. 27 is a side elevational view of the track drives of one embodiment of the present invention, showing the shallow “V” shape of the lower track surface. In the illustrated embodiment each track drive comprises a flexible track rotating around a set of wheels and/or rollers. Each set of wheels and/or rollers includes a rear weight-bearing wheel assembly, a center weight-bearing wheel assembly, a forward weight-bearing wheel assembly, a front roller assembly, and an upper roller assembly. The rear weight-bearing wheel, the center weight-bearing wheel, and the forward weight-bearing wheel are fixed to the frame at a height effective to cause the main weight-bearing surface defined by that portion of each track drive to always have a “V”-shaped lower surface when viewed from the side, and never to have a flat lower surface when viewed from the side. The center weight-bearing wheel, the forward weight-bearing wheel, and the front roller are fixed to the frame at a height effective to cause that portion of each track drive always to have a “V”-shaped lower surface when viewed from the side, and never to have a flat lower surface when viewed from the side. The rear surface of the rear weight-bearing wheel, the front end portion of the front roller, and the lower portions of the central weight-bearing wheel and the forward weight-bearing wheel all contact the flexible track. The upper surfaces of the central weight-bearing wheel and the forward weight-bearing wheel remain free from contact with the track.

More particularly describing the illustrated embodiment, each illustrated track drive comprises:
i) a rear weight-bearing wheel (R);
ii) a center weight-bearing wheel (CWB);
iii) a forward weight-bearing wheel (FWB);
iv) a forward roller (FR);
iv) an upper roller (UR);
v) an endless track looped around and contacting all of said wheels to define:
   A) a first linear portion R-CWB between the rear weight-bearing wheel and the center weight-bearing wheel;
   B) a second linear portion CWB-FWB between the center weight-bearing wheel and the forward weight-bearing wheel;
   C) a third linear portion FWB-FR between the forward weight-bearing wheel and the forward roller;
   D) a fourth portion FR-UR between the forward roller and the upper roller;
   E) a fifth portion UR-R between the upper roller and the rear wheel.

The bottom surfaces of the center weight-bearing wheel (CWB) and the forward weight-bearing wheel (FWB) are arranged to define a line CWB/FWB. Similarly, the bottom surfaces of the center weight-bearing wheel (CWB) and rear weight-bearing wheel R are arranged to define a line CWB/R. An angle α is defined by those lines, as illustrated. Angle α is preferably less than 15 degrees, and more preferably less than 10 degrees, and most preferably no more than 5 degrees. In the illustrated embodiment angle α is about 2 degrees.

Additionally, the bottom surfaces of forward weight-bearing wheel FWB and forward roller FR are arranged to define a line FWB/FR. An angle β is defined by those lines, as illustrated. Angle β is preferably more than 15 degrees, and more preferably more than 20 degrees, and most preferably about 30 degrees.

As previously indicated, forward roller FR extends forward from front weight-bearing roller FWB a distance effective to cause the foremost portion of the track to be raised to a height effective to allow the device to easily climb over standard curbs. Accordingly, forward roller FR extends forward from front weight-bearing roller FWB a distance effective to cause the foremost portion of the bottom of the track to be raised about 6-12 inches, and most preferably about 8-10 inches, above “ground” level.

FIG. 31 illustrates one embodiment of a frame assembly for use in the present invention. Frame assembly 220 a main, horizontal portion 224 and an upward angled forward portion 225 that holds the forward roller. Forward angled portion 225 is adjustable by sliding members 227 to allow the roller attached thereto to be moved closer or farther from front weight-bearing wheel FWB, thus increasing or decreasing the tension on track 217 and allowing the track to be removed from the device.

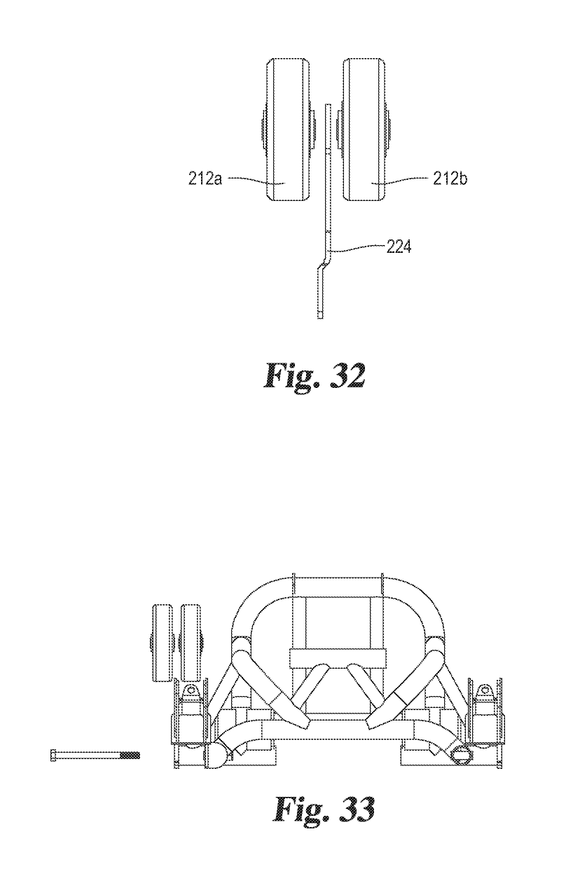

FIG. 32 illustrates how any or all of the wheels and/or rollers such as RWB, CWB, FWB, FR, and UR may be provided as a wheel/roller pair, rather than as a single wheel or roller. When a wheel or roller pair is used, one of each pair is mounted to one side of the frame member and the other of each pair is mounted to the other side of the frame member. The space between the wheel/roller pairs is used to guide a center ridge of the flexible track, thereby keeping the flexible track centered as it passes over the wheels and/or rollers.

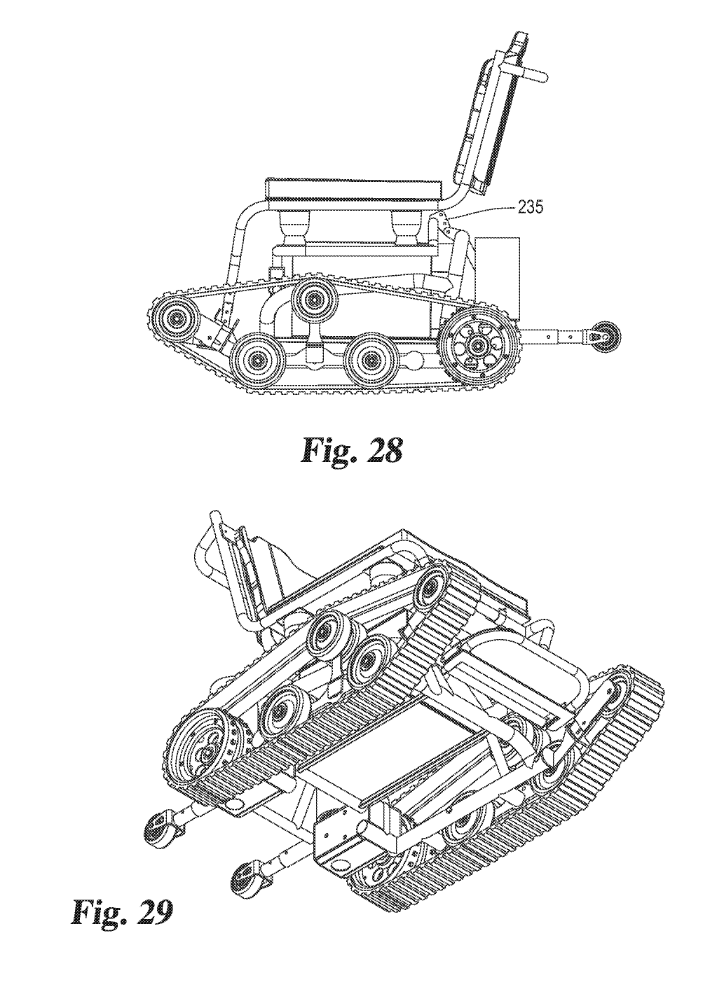

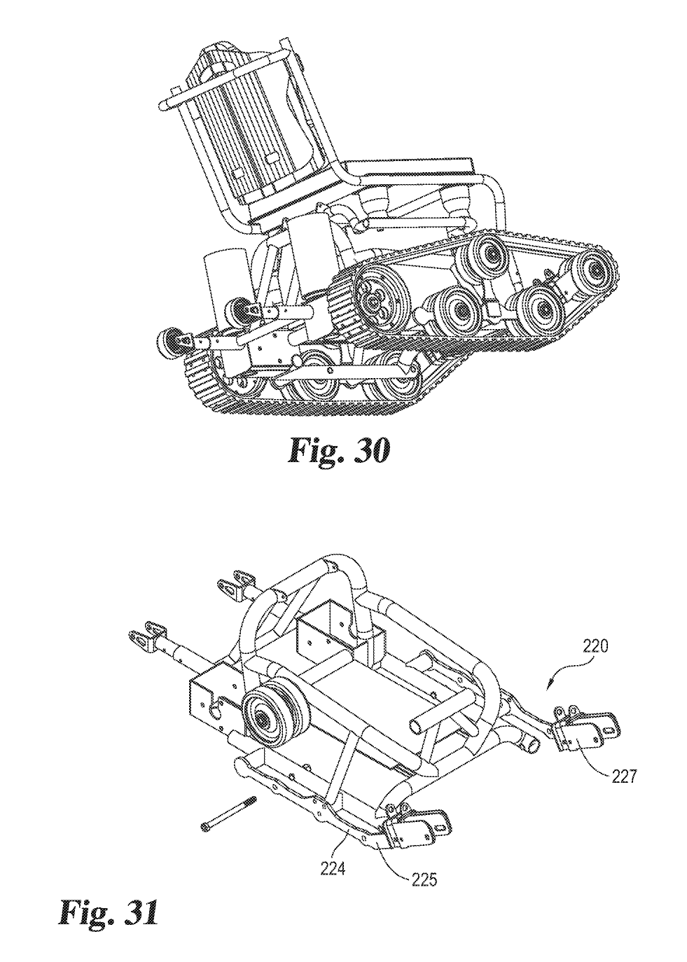

While the invention has been illustrated and described in detail in the drawings and foregoing description, the same are to be considered illustrative and not restrictive in character, it being understood that only certain illustrative embodiments are shown and described and that all changes and modifications that come within the spirit of the invention are desired to be protected. In addition, it is to be appreciated that the present invention may comprise or consist essentially of any or all of the illustrated features. For example, the present invention includes devices comprising any or all of the features illustrated in FIGS. 1 through 33, and the present invention includes devices consisting essentially of any of any or all of those features Additionally, any or all of the features and/or embodiments disclosed in the documents that have been incorporated herein by reference may be combined with any or all of the features disclosed herein to provide a device that comprises or consists essentially of such features.

1. A tracked mobility device, comprising:
a) a frame supporting a seat assembly comprising a seat;
b) a pair of track drives connected to said frame, with each track drive comprising a flexible track rotating around a set of wheels and/or rollers,
wherein at least one of said set of wheels and/or rollers is a powered drive wheel; and
wherein each set of wheels and/or rollers includes a rear weight-bearing wheel assembly, a center weight-bearing wheel assembly, a forward weight-bearing wheel assembly, a front roller assembly, and an upper roller assembly;
wherein the rear weight-bearing wheel, the center weight-bearing wheel, and the forward weight-bearing wheel are provided on the frame at a height effective to cause the main weight-bearing surface defined by that portion of each track drive to always have a “V”-shaped lower surface when viewed from the side, and never to have a flat lower surface when viewed from the side; and
wherein the center weight-bearing wheel, the forward weight-bearing wheel, and the front roller are fixed to the frame at a height effective to cause that portion of each track drive always to have a “V”-shaped lower surface when viewed from the side, and never to have a flat lower surface when viewed from the side; and
c) a controller effective for controlling the speed and direction of rotation of each of the track drives.

2. A tracked mobility device according to claim 1 wherein the device further includes an independent rear wheel assembly connected to said frame and comprising a multi-directional wheel that may be raised or lowered to provide a three-point contact with a flat surface; and

3. A tracked mobility device according to claim 1 wherein the device further includes an upper tensioning roller assembly.

4. A tracked mobility device according to claim 1 wherein the rear surface of the rear weight-bearing wheel, the front end portion of the front roller, and the lower portions of the central weight-bearing wheel and the forward weight-bearing wheel all contact the flexible track, and wherein the upper surfaces of the central weight-bearing wheel and the forward weight-bearing wheel remain free from contact with the track.

5. A tracked personal mobility device, comprising:
a) a frame assembly;
b) a pair of track drives directly or indirectly mounted to the frame assembly, with each track drive comprising:
i) a rear weight-bearing wheel (R);
ii) a center weight-bearing wheel (CWB);
iii) a forward weight-bearing wheel (FWB);
iv) a forward roller (FR);
iv) an upper roller (UR);
v) an endless track looped around and contacting all of said wheels to define:
A) a first linear portion R-CWB between the rear weight-bearing wheel and the center weight-bearing wheel;
B) a second linear portion CWB-FWB between the center weight-bearing wheel and the forward weight-bearing wheel;
C) a third linear portion FWB-FR between the forward weight-bearing wheel and the forward roller;
D) a fourth portion FR-UR between the forward roller and the upper roller;
E) a fifth portion UR-R between the upper roller and the rear wheel;
c) a seat assembly;
d) a motor operably connected to the track drive and effective to turn at least one of the wheels and/or rollers of the track drive; and
e) a controller to control the speed and direction of rotation of the power/drive wheel.

6. A tracked mobility device, comprising:
a) a frame supporting a seat assembly comprising a seat;
b) a pair of track drives connected to said frame, with each track drive comprising a flexible track rotating around a set of wheels and/or rollers,
wherein each set of wheels and/or rollers includes a powered rear drive wheel, an unpowered central weight-bearing wheel, and an unpowered front roller wheel;
wherein the powered rear drive wheel, unpowered central weight-bearing wheel, and unpowered front roller wheel of each track are fixed to said frame at a height effective to cause each track drive always to have a “V”-shaped lower surface when viewed from the side, with the “V”-shape being defined by a raised front end portion, a raised rear end portion, and a lowered central portion, and never to have a flat lower surface when viewed from the side;
wherein the rear end portion of each track contacts the a rear surface of the powered rear drive wheel, the front end portion of each track contacts the a front surface of the unpowered front roller wheel, and the lowered central portion of each track contacts only the a lower surface of the central weight-bearing wheel, with the an upper surface of the central weight-bearing wheel being free from contact with the track; and
c) a controller effective for controlling the speed and direction of rotation of each of the track drives.

7. A tracked mobility device according to claim 6 wherein the device further includes an independent rear wheel assembly connected to said frame and comprising a rear wheel positioned at a fixed and constant height with respect to said frame, wherein said fixed and constant height is effective to allow the rear wheel to cooperate with the lowered central portion of each of said track drives to provide a three-point contact with a flat surface.
